(19) United States
(12) Patent Application Publication
(10) Pub. No.: US 2021/0218807 A1
(43) Pub. Date: Jul. 15, 2021

(54) REAL-TIME REPLICATION OF OBJECT STORAGE IN CLOUD STORAGE

(71) Applicant: EMC IP Holding Company LLC, Hopkinton, MA (US)

(72) Inventors: Yossef Saad, Ganei Tikva (IL); Saar Cohen, Moshav Mishmeret (IL)

(21) Appl. No.: 16/742,258

(22) Filed: Jan. 14, 2020

(51) Int. Cl. H04L 29/08; H04L 29/06; G06F 3/06; G06F 21/60; G06F 16/27; H04W 88/16; G06F 9/455

(52) U.S. Cl. CPC H04L 67/1097; H04L 63/20; G06F 3/067; G06F 2009/45595; G06F 16/27; H04W 88/16; G06F 9/45558; G06F 21/602

(57) ABSTRACT

Data protection operations including replication operations, transport operations, and/or access operations. A data protection engine may include a function as a service that allows data to be replicated and transported intracloud and intercloud. The data protection engine also allows point-in-time access to data stored in the cloud and/or replicated in the cloud.

### FIELD OF THE INVENTION

Embodiments of the present invention generally relate to data protection operations. More particularly, at least some embodiments of the invention relate to systems, hardware, software, computer-readable media, and methods for performing data protection operations including data replication operations in cloud-based storage environments.

### BACKGROUND

Object storage is a common way to store data in public clouds. Cloud-based storage is allegedly inexpensive, durable, and easy to use. Storage providers, such as AWS, Microsoft Azure, and Google Cloud Platform allow users to store information of any type and many users store important information in the cloud. Various types of storage are available.

Although efforts are made to make the storage persistent and durable, organizations that store critical data in the cloud are often required or interested in a mechanism that allow their data stored in the cloud to be recovered. For example, the cloud may fail or may experience data loss.

Cloud providers provide the capability of replicating data between availability zones or regions within their own systems. However, these mechanisms are based on transporting snapshots of the objects and are not performed in real time. As a result, the amount of data that may be lost in case of a failure, which is often reflected in the RPO (Recovery Point Objective), is high. There is no mechanism that allows or enables real-time or near real-time replication of data in cloud-based storage systems. In other words, the ability to copy data to another location as soon as the data is updated is limited in cloud-based storage. Further, the ability to replicate data from one cloud-provider to another cloud-provider is not present.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of systems and methods for performing data protection operations including replication operations in an intracloud or intercloud manner;

FIG. 2 discloses aspects of systems and methods for optimizing replication operations by performing transport operations;

FIG. 3 illustrates an example of systems and methods for accessing point-in-time versions of objects or other data; and

FIG. 4 illustrates an example method for performing data protection operations including replication operations, transport operations, and/or access operations.

### DETAILED DESCRIPTION OF SOME EXAMPLE EMBODIMENTS

Embodiments of the present invention generally relate to data protection operations. More particularly, at least some embodiments of the invention relate to systems, hardware, software, computer-readable media, and methods for data protection operations including replication operations, backup operations, restore operations, copying operations, deduplication operations, transport operations, point-in-time (PiT) data operations, or the like or combination thereof.

In general, embodiments of the invention relate to replicating data in real time or near real time in cloud-based storage systems or from one cloud-based storage system to another cloud-based storage system. Embodiment of the invention relate to the replication of object storage by copying objects (or other data in other formats) as the objects are written into the cloud-based storage. Embodiments of the invention may also relate to a function as a service (FaaS) that replicates data. The FaaS may also provide the ability to access any PiT in the stored data. Embodiments of the invention replicate data with near-real-time (very low RPO) to the same and/or a different cloud-based storage.

Data protection operations can be performed in a variety of different scenarios and performed on various types of data. Embodiments of the invention relate to replicating data from an on-premise site (e.g., a local site) or a cloud-based site. The operations discussed herein are performed using or implemented in hardware such as processors, memory (of different types), switches, networks, or the like or other hardware used in computing environments.

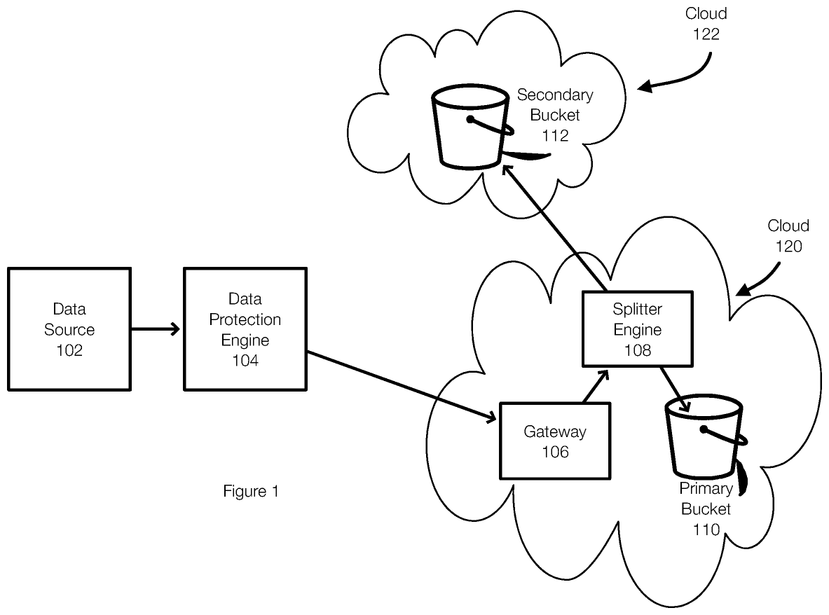

FIG. 1 illustrates an example of replicating data from a source (e.g., an on-premise source or a cloud-based source, or other source such as a storage). FIG. 1 illustrates a data protection engine 104 configured to perform data protection operations with respect to the data source 102. In one example, the data protection engine 104 (e.g., an appliance, server-client or server-agent, virtual machine, or the like) is configured to transport data stored at the data source 102 to the cloud 120. This may be part of a larger replication operation, where the data is replicated in the cloud. In other words, data replicated from the source 102 to the cloud 120 may be further replicated in one example. The data protection engine 104 may be implemented as or on a physical machine and/or virtual machine or in other configurations.

The cloud 122 may be a cloud-based storage that is separate and independent of the cloud 120. Alternatively, the cloud 122 may be another region or portion of the cloud 120. By the data protection operation shown in FIG. 1, the data transmitted from the data source 102 is stored in the primary bucket 110 and in the secondary bucket 112. As the data arrives at the cloud 120, the data is replicated such that the data is stored in the cloud 120 and in the cloud 122.

Embodiments of the invention may provide a splitter engine 108 (an example of a data protection engine or a portion of a data protection engine) that is further configured to replicate the data directed to one target to another target such as the cloud 122. The splitter engine 108 may be implemented as a FaaS. In this example, the splitter engine 108 is configured to send the data received from the data source 102 to the primary bucket 110 and send the data (or a copy thereof) to the secondary bucket 112. Advantageously, the splitter engine 108 replicates cloud based objects or data in real-time or in near real time with low RPO.

In this example, the splitter engine 108 is associated with a gateway 106, which may be an API gateway. The gateway 106 is an interface between clients and the cloud or between clients and functions that may be performed in the cloud. By way of example only, the gateway 106 may be a server that provides an entry point into the cloud. The gateway 106 may provide routing, protocol translation, and the like. The gateway 106 is configured to serve as a proxy for incoming commands (including PUT and GET commands) and may handle or provide the same set of APIs often supported by the cloud 120 (e.g., APIs supported by AWS or other cloud provider). In this example, the gateway 106 is configured to provide an entry point to a user, such as the data protection engine 104, and redirect the data and operations to the splitter engine 108. The splitter engine 108 is configured to replicate the incoming data to the primary bucket 110 and the secondary bucket 112.

More specifically in one example, the gateway 106 is a point of entry into services or functions and may be associated with a URL (Uniform Resource Locator). Thus, the data protection engine 104 directs commands (calls, requests, etc.), such as PUT commands, to the gateway 106. The gateway 106 can receive commands from clients such as the data protection engine 104 and route the requests to the appropriate services or functions.

In one example, the gateway 106 may be provided by the cloud 120 (e.g., by the cloud provider) or by a third party. In effect, a data protection system, when implemented, may provide the gateway 106 to provide data protection functionality. In this example, the gateway 106 may provide an endpoint that is different from the endpoint that would be provided by the cloud 120 when the cloud provides the gateway 106. However, the data protection system can still use the same software development kit (SDK) and application programming interfaces (APIs). The endpoint, however, may be modified when provided by a third party. More specifically, the URL endpoints that the APIs point at should be modified and different certificates may be required. However, no changes to the data protection application are required and the data protection system can be implemented using the customized gateway or the cloud-provided gateway. In other words, regardless of who provides the gateway 106, no fundamental changes are required for the splitter engine 108.

The splitting engine 106 may be implemented as a Lambda function or other service. The splitting engine 106, by way of example only, may be a serverless function that may respond to events. For example, when attempting to access the primary bucket 110 via the gateway 106, the data path is configured such that the splitter engine 108 is invoked and the function of the splitter engine 108 is performed. In one example, the splitter engine 108 is invoked when accessing or writing to the primary bucket 110 rather than after an object is written to the primary bucket 110, although this method is not excluded in embodiments of the invention.

In this example, when data is sent from the data source 102 (whether by a user or by the data protection engine 104 or by other application), the gateway 106 receives or intercepts the command or request. Thus, the gateway 106 receives (e.g., the PUT command) the command and provides or directs the command to the splitter engine 108 that is invoked in response to receiving command.

The splitter engine 108 writes the data to the primary bucket 110 using the PUT command. The splitter engine 108 also writes the data to the secondary bucket 112 using a PUT command in one example.

When accessing (e.g., reading) the data from the cloud 120 or the cloud 122, The gateway 106 and/or the splitter 108 may not be involved in the data path. A GET command, for example, can be performed without the gateway 106 and without the splitter engine 108. The data may be read using an appropriate URL for example and a GET command.

In addition to replicating data as described in FIG. 1, the replication operation can be performed with additional functionality.

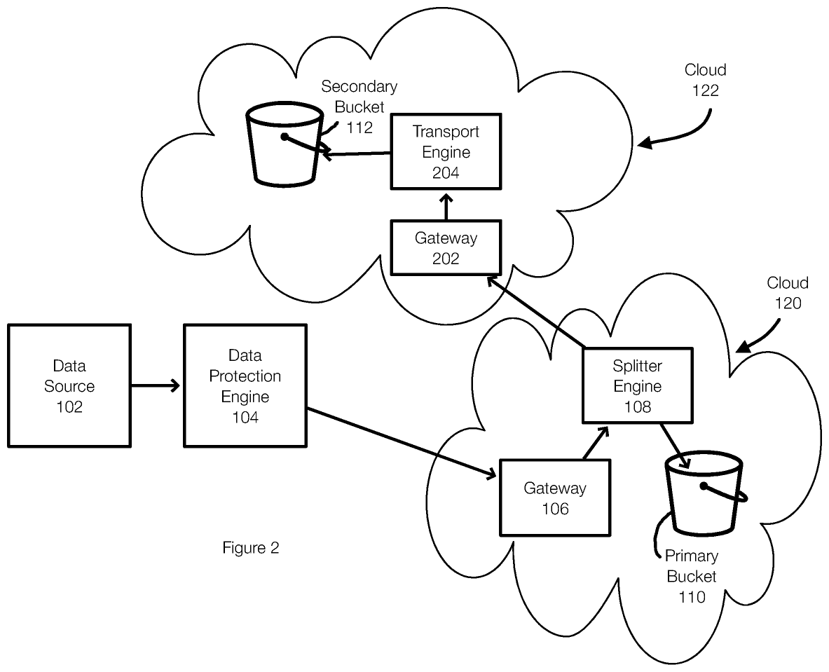

FIG. 2 illustrates an example of a system in which data protection operations are performed. FIG. 2 illustrates both replication operations and transport operations. In one example, the transport operations are incorporated into or performed as part of the replication operations. Because writing data from the cloud 120 to the cloud 122 may be expensive at least in terms of network bandwidth and latency, the transmission of data is optimized.

In this example, the client (e.g., the data protection engine 104) may still access the endpoint provided by the gateway 106. During performance of the data protection operations, another gateway may be accessed or used. FIG. 2 illustrates that the cloud 122 may be associated with a gateway 202 and a transport engine 204 that is used when replicating the data.

In this example, the gateway 202 is configured to a direct a write command from the splitter engine 108 to a transport engine 204. While performing replication, the splitter engine 108 may also perform transport operations such as compression, deduplication, encryption, or the like for data being transported to the cloud 122. The transport engine 204, which may also be a lambda function or service that is invoked upon receipt of a write command by the gateway 202, may be configured to perform various functions such as decompression, decryption, or the like as desired.

More specifically, data from the data source 102 may be sent to the gateway 106 in the context of a PUT command or a write command. The gateway 106 intercepts the command and provides or directs the command and the data to the splitter engine 108 that is invoked in response to the command. The splitter engine 108 receives the data and writes the data to the primary bucket 110 using, for example, a PUT command. The splitter engine 108 also performs transport functions or optimizations such as compression, encryption, deduplication, or the like. The optimized data is then sent using a command (e.g., a specialized or proprietary WRITE command) to the gateway 202 associated with the cloud 122. The WRITE command may be specialized by syntax such that the functions to be performed can be invoked.

The gateway 202 identifies or recognizes the specialized command, invokes the transport engine 204 and sends the data to the transport engine 202. The transport engine 204 may reconstruct the data. More specifically in one example, the transport engine 204 may perform inverse transport operations that reverse the effect of the transport operations performed by the splitter engine 108 if necessary. For example, the transport engine 204 may decompress the data, decrypt the data, handle the impact of deduplication, and the like. The transport engine 204 then writes the data to the secondary bucket 112 using, for example, a standard PUT command.

A read operation or a GET command may not involve the gateways 106, 202 or the splitter engine 108 or the transport engine 204 during this type of replication. However the use of the gateways is not precluded for GET commands.

Embodiments of the invention also allow virtual or read access to (PIT) versions. More specifically, the splitter engine 108 can be leveraged with respect to a read or a GET command to enable access to any point in time. In this example, a gateway is introduced into the GET path and an access engine, which is able to access PiT copies, is invoked. The access engine may be part of the splitter engine.

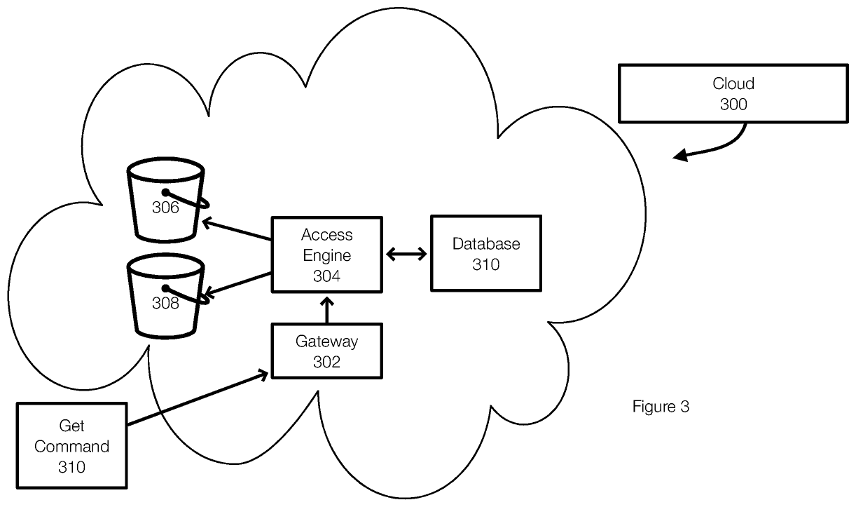

FIG. 3 illustrates an example of an access function implemented in a cloud system. FIG. 3 illustrates a gateway 302 that receives a GET command 310 (or other access or read request). Upon receiving the GET command 310, the gateway 302 invokes the access engine 304 and sends the command to the access engine 304. Stated differently, the receipt of the GET command is an event that invokes the access engine.

In FIG. 3, data is stored in the bucket 306. In one example, the bucket 306 is an example of the secondary bucket to which data has been replicated. PiT data is stored in the bucket 308 (which may be a part of the bucket 306 in one example). The data protection system may prepare indexes that map the objects into their PiT representations. The index may be stored in a database 310. More specifically, the data protection system may prepare the indexes that map the objects (the data stored in the bucket 306 and/or in other buckets) to their point in time representations.

For example, a user may select a specific point in time to access (PiT-t). If the name of the object is “/docs/document.doc” in the bucket 306. The point in time data is kept in the bucket 308 as object “/pit-{t}/docs/document.doc”.

When a GET command or request is received for the “/docs/document.doc” and a point in time is specified, the user may request the object using its path “bucket 306/docs/document.doc”. The access engine 304 will automatically direct this call to retrieve “bucket 308/pit_{t}/docs/document.doc”.

This allows a user to access an image of the data from any selected point in time, without having to modify anything in the access engine or code that retrieves the requested objects. More specifically, embodiments of the invention do not change the name of the objects. Rather, the index allows the requested PiT object to be retrieved. All that is modified is the object to which the name points. By specifying the point in time, the access engine 304 may be invoked in response to the specialized command to access the index in the database 310 in order to access the appropriate PiT object.

Embodiments of the invention thus allow objects (or other data) to be written to the cloud, accessed from the cloud, replicated within the cloud, PiT accessed, or the like or combination thereof.

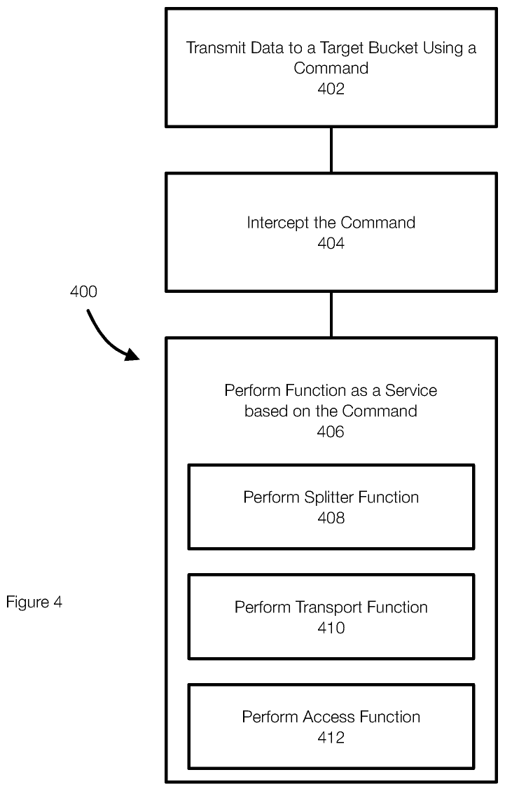

FIG. 4 illustrates an example of a method for performing data protection operations including replication operations, transport operations, and or access operations. These operations may be performed at the same time, or at different times. Further, some operations may be performed as an optimization of other operations. For example, a transport operation may optimize a replication operation.

FIG. 4 illustrates a method 400 for performing various operations. Initially, a command and/or data is transmitted 402 using a command or a request. The command may be directed to a specific gateway that allows functions to be provided as a service. In some instances, however, the gateway may not be part of the data path. In this example, the command and/or data may be intercepted 404 by a gateway. This allows the gateway to parse or interpret the command such that the appropriate function can be invoked or such that the command/data can be directed to the appropriate engine or function.

After interpreting the command, the function based on the command is performed 406. Performing the function may involve the transmission of the data and/or additional commands to other gateways. For example, invoking 408 a splitter function may cause the data received via the gateway to be written to a primary bucket in a first cloud and simultaneously or in another manner transmitting the data to a secondary bucket in the same cloud or in a different cloud. Thus, the splitter function, implemented by a splitter engine, allows data to be replicated in the cloud (intracloud or intercloud replication).

A transport function may also be performed 410. The transport operation may prepare the data for transport to the secondary bucket by way of example only during a replication operation. For instance, when the secondary bucket is in another cloud, the data is prepared or packaged for transport in a manner that, by way of example, reduces network and bandwidth requirements or usage (e.g., compression, de-duplication, etc.). The secondary cloud may be associated with a gateway and a transport engine that is invoked in order to effectively undo the transport optimizations performed by the transmitting splitter or transport engine.

In another example, an access function may be performed 412. This may occur in the context of access or read requests and may result in the gateways discussed herein being part of the read path. The access function allows PiT versions or copies to be accessed without requiring a change in the underlying engines. Rather, index information is generated and used to access the correct objects based on a time provided by a user.

For example, the data being replicated may include backup data. The index information may map an object to the various versions or representations in the backup or in a bucket. Thus, when a time is specified, the object corresponding to the requested PiT can be accessed. As the objects or data is stored in the various buckets, the index allows the request to be directed to the appropriate object/bucket. When an object name is received, the index information identifies a name that points to the appropriate PiT objects based, in one example, on the identified time.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, data protection operations. Such operations may include, but are not limited to, data read/write/delete operations, data deduplication operations, data backup operations, data restore operations, data cloning operations, data archiving operations, and disaster recovery operations. More generally, the scope of the invention embraces any operating environment in which the disclosed concepts may be useful.

At least some embodiments of the invention provide for the implementation of the disclosed functionality in existing backup platforms, examples of which include the Dell-EMC NetWorker and Avamar platforms and associated backup software, and storage environments such as the Dell-EMC DataDomain storage environment. In general however, the scope of the invention is not limited to any particular data backup platform or data storage environment.

New and/or modified data collected and/or generated in connection with some embodiments, may be stored in a data protection environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to service read, write, delete, backup, restore, and/or cloning, operations initiated by one or more clients or other elements of the operating environment. Where a backup comprises groups of data with different respective characteristics, that data may be allocated, and stored, to different respective targets in the storage environment, where the targets each correspond to a data group having one or more particular characteristics.

Example public cloud storage environments in connection with which embodiments of the invention may be employed include, but are not limited to, Microsoft Azure, Amazon AWS, and Google Cloud. More generally however, the scope of the invention is not limited to employment of any particular type or implementation of cloud storage.

In addition to the storage environment, the operating environment may also include one or more clients that are capable of collecting, modifying, and creating, data. As such, a particular client may employ, or otherwise be associated with, one or more instances of each of one or more applications that perform such operations with respect to data.

Devices in the operating environment may take the form of software, physical machines, or virtual machines (VM), or any combination of these, though no particular device implementation or configuration is required for any embodiment. Similarly, data protection system components such as databases, storage servers, storage volumes (LUNs), storage disks, replication services, backup servers, restore servers, backup clients, and restore clients, for example, may likewise take the form of software, physical machines or virtual machines (VM), though no particular component implementation is required for any embodiment. Where VMs are employed, a hypervisor or other virtual machine monitor (VMM) may be employed to create and control the VMs. The term VM embraces, but is not limited to, any virtualization, emulation, or other representation, of one or more computing system elements, such as computing system hardware. A VM may be based on one or more computer architectures, and provides the functionality of a physical computer. A VM implementation may comprise, or at least involve the use of, hardware and/or software. An image of a VM may take various forms, such as a .VMDK file for example.

As used herein, the term ‘data’ is intended to be broad in scope. Thus, that term embraces, by way of example and not limitation, data segments such as may be produced by data stream segmentation processes, data chunks, data blocks, atomic data, emails, objects of any type, files of any type including media files, word processing files, spreadsheet files, and database files, as well as contacts, directories, sub-directories, volumes, and any group of one or more of the foregoing.

Example embodiments of the invention are applicable to any system capable of storing and handling various types of objects, in analog, digital, or other form. Although terms such as document, file, segment, block, or object may be used by way of example, the principles of the disclosure are not limited to any particular form of representing and storing data or other information. Rather, such principles are equally applicable to any object capable of representing information.

As used herein, the term ‘backup’ is intended to be broad in scope. As such, example backups in connection with which embodiments of the invention may be employed include, but are not limited to, full backups, partial backups, clones, snapshots, and incremental or differential backups.

Following are some further example embodiments of the invention. These are presented only by way of example and are not intended to limit the scope of the invention in any way.

Embodiment 1. A method for performing a replicating objects in a cloud-based environment, the method comprising intercepting a command to store data in a primary bucket in a first cloud, invoking a function based on the command, and performing the function by writing the data to the primary bucket and by writing the data to a secondary bucket in a second cloud.

Embodiment 2. The method of embodiment 1, wherein the first cloud and the second cloud are independent of each other or where the second cloud is a different part of the first cloud.

Embodiment 3. The method of embodiment 1 and/or 2, wherein the function is a function as a service.

Embodiment 4. The method of embodiment 1, 2 and/or 3, wherein the function is invoked in response to the command, the method further comprising receiving the command at a gateway provided by the first cloud or by a third party.

Embodiment 5. The method of embodiment 1, 2, 3 and/or 4, further comprising invoking a transport function on the data before writing the data to the secondary bucket, wherein the transport function optimized the data for transport to the second cloud.

Embodiment 6. The method of embodiment 1, 2, 3, 4 and/or 5, wherein the transport function includes one or more of compression, de-duplication and/or encryption.

Embodiment 7. The method of embodiment 1, 2, 3, 4, 5 and/or 6, further comprising writing the data to the secondary bucket with a second command issued to a second gateway associated with the second cloud.

Embodiment 8. The method of embodiment 1, 2, 3, 4, 5, 6, and/or 7, further comprising invoking the transport function at the second cloud in response to receiving the second command, wherein the transport function at the second cloud unpackages the data from the transport operations performed by the transport function at the first cloud.

Embodiment 9. The method of embodiment 1, 2, 3, 4, 5, 6, 7, and/or 8, further comprising receiving an access request at a second gateway associated with the second cloud for a point-in-time copy of an object, wherein a time is identified by a user.

Embodiment 10. The method of embodiment 1, 2, 3, 4, 5, 6, 7, 8, and/or 9, further comprising mapping the access request for the object to the point-in-time copy and returning the point-in-time copy in response to the access request.

Additional embodiments. Apparatus configured to perform the methods of any one or more of embodiments 1-10. A non-transitory storage medium having stored therein instructions that are executable by one or more hardware processors to perform the operations of any one or more of embodiments 1 through 10.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

Any one or more of the entities disclosed, or implied herein, may take the form of, or include, or be implemented on, or hosted by, a physical computing device. As well, where any of the aforementioned elements comprise or consist of a virtual machine (VM), that VM may constitute a virtualization of any combination of the physical components disclosed herein.

The physical computing device includes a memory which may include one, some, or all, of random access memory (RAM), non-volatile random access memory (NVRAM), read-only memory (ROM), and persistent memory, one or more hardware processors, non-transitory storage media, UI device, and data storage. One or more of the memory components of the physical computing device may take the form of solid state device (SSD) storage. As well, one or more applications may be provided that comprise instructions executable by one or more hardware processors to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud storage site, client, datacenter, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for replicating objects in a cloud-based environment, the method comprising:
intercepting a command to store data in a primary bucket in a first cloud;
invoking a function based on the command; and
performing the function by writing the data to the primary bucket and by writing the data to a secondary bucket in a second cloud.

2. The method of claim 1, wherein the first cloud and the second cloud are independent of each other or wherein the second cloud is a different part of the first cloud.

3. The method of claim 1, wherein the function is a function as a service.

4. The method of claim 1, wherein the function is invoked in response to the command, the method further comprising receiving the command at a gateway provided by the first cloud or by a third party.

5. The method of claim 1, further comprising invoking a transport function on the data before writing the data to the secondary bucket, wherein the transport function optimized the data for transport to the second cloud.

6. The method of claim 5, wherein the transport function includes one or more of compression, de-duplication and/or encryption.

7. The method of claim 5, further comprising writing the data to the secondary bucket with a second command issued to a second gateway associated with the second cloud.

8. The method of claim 7, further comprising invoking the transport function at the second cloud in response to receiving the second command, wherein the transport function at the second cloud unpackages the data from the transport operations performed by the transport function at the first cloud.

9. The method of claim 1, further comprising receiving an access request at a second gateway associated with the second cloud for a point-in-time copy of an object, wherein a time is identified by a user.

10. The method of claim 9, further comprising mapping the access request for the object to the point-in-time copy and returning the point-in-time copy in response to the access request.

11. A non-transitory storage medium having stored therein instructions that are executable by one or more hardware processors to perform operations for performing a data protection operation, the operations comprising:
intercepting a command to store data in a primary bucket in a first cloud;
invoking a function based on the command; and
performing the function by writing the data to the primary bucket and by writing the data to a secondary bucket in a second cloud.

12. The non-transitory storage medium of claim 11, wherein the first cloud and the second cloud are independent of each other or where the second cloud is a different part of the first cloud.

13. The non-transitory storage medium of claim 11, wherein the function is a function as a service.

14. The non-transitory storage medium of claim 11, wherein the function is invoked in response to the command, the operations further comprising receiving the command at a gateway provided by the first cloud or by a third party.

15. The non-transitory storage medium of claim 11, the operations further comprising invoking a transport function on the data before writing the data to the secondary bucket, wherein the transport function optimized the data for transport to the second cloud.

16. The non-transitory storage medium of claim 15, wherein the transport function includes one or more of compression, de-duplication and/or encryption.

17. The non-transitory storage medium of claim 15, the operations further comprising writing the data to the secondary bucket with a second command issued to a second gateway associated with the second cloud.

18. The non-transitory storage medium of claim 17, the operations further comprising invoking the transport function at the second cloud in response to receiving the second command, wherein the transport function at the second cloud unpackages the data from the transport operations performed by the transport function at the first cloud.

19. The non-transitory storage medium of claim 11, the operations further comprising receiving an access request at a second gateway associated with the second cloud for a point-in-time copy of an object, wherein a time is identified by a user.

20. The non-transitory storage medium of claim 19, the operations further comprising mapping the access request for the object to the point-in-time copy and returning the point-in-time copy in response to the access request.
